(19) United States
(12) Patent Application Publication
(10) Pub. No.: US 2011/0283192 A1
(43) Pub. Date: Nov. 17, 2011

(54) SYSTEM AND METHOD FOR DATA MANAGEMENT IN A COMMUNICATION DEVICE

(75) Inventors: TZU-CHENG YU, Santa Clara, CA (US); JIING-RENN YU, Tu-Cheng (TW); YU-SHENG HOU, Tu-Cheng (TW); BOR-CHUAN LIN, Tu-Cheng (TW); JIAN-CHENG LIN, Tu-Cheng (TW); EL-HINN ELIZABETH, Tu-Cheng (TW); PEI-HSI CHENG, Tu-Cheng (TW); HUNG-CHANG WEI, Tu-Cheng (TW); YUN-JU CHEN, Tu-Cheng (TW); PEI-JU CHEN, Tu-Cheng (TW)

(73) Assignee: CHI MEI COMMUNICATION SYSTEMS, INC., Tu-Cheng City (TW)

(21) Appl. No.: 12/871,948

(22) Filed: Aug. 31, 2010

(30) Foreign Application Priority Data
May 11, 2010 (TW) 99114873

(51) Int. Cl. G06F 3/01; G06F 15/16

(52) U.S. Cl. 715/733

(57) ABSTRACT

A communication device and a method for data management include setting relevant information for contacts in a contact list to one or more social network applications, and confirming contacts associated with a specific social network application when the communication device runs the specific social network application. The method includes obtaining current status of the confirmed contacts from the social network application, arranging all the contacts in the contact list according to the current status of the confirmed contacts and showing the contact list in an arranged order on a display.

### BACKGROUND

1. Technical Field

Embodiments of the present disclosure relate to communication devices, and in particular, to a system and method for data management in a communication device.

2. Description of Related Art

People may communicate with each other using various social network platforms in communication devices, such as a mobile phone. Contact lists in the communication devices may provide information for people, such as a contact information of a contact in the contact list. However, because there is no association between the contact list and the social network platforms, people cannot know status of contacts in the social network platforms through the contact list.

### BRIEF DESCRIPTION OF THE DRAWINGS

FIG. 1 is a block diagram of one embodiment of a communication device including a data management system.

FIG. 2 is a block diagram of one embodiment of the data management system of FIG. 1.

FIG. 3 is a schematic diagram of one embodiment of the data management system of FIG. 1.

FIG. 4 is a flowchart of one embodiment of a method for data management in a communication device, such as, for example, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system.

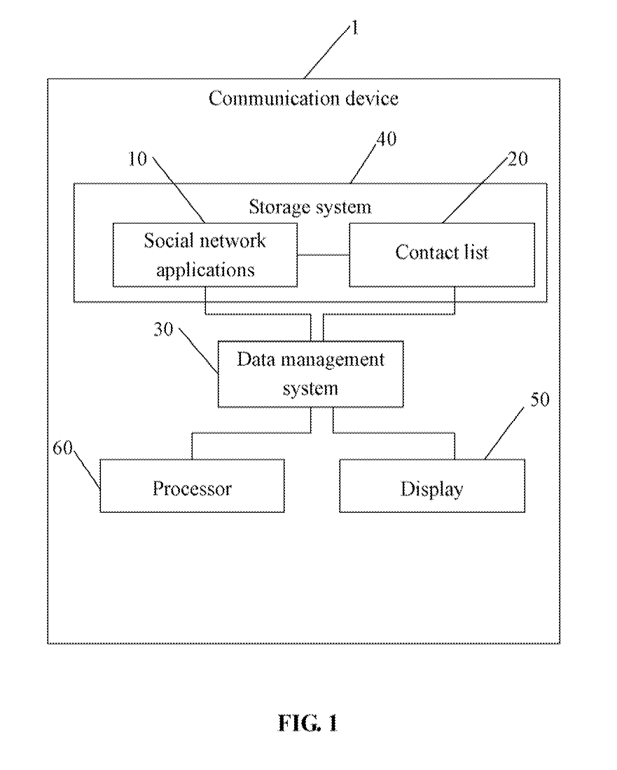

FIG. 1 is a block diagram of one embodiment of a communication device 1 including a data management system 30. The communication device 1 may include a storage system 40 that stores one or more social network applications 10 and a contact list 20. The data management system 30 may arrange contacts in a contact list of the communication device 1 according to current status of the contacts in the one or more social network applications 10. The one or more social network applications 10 are network software for people to communicate. The contact list 20 records contact information and related information of contacts, such as home addresses, e-mail addresses, instant messenger accounts, and phone numbers, for example. The storage system 40 may be a memory system of the communication device 1, and also may be an external storage card, such as a smart media (SM) card, or secure digital (SD) card, for example.

The communication device 1 further includes a display 50 and a processor 60. The display 50 may output visible data, such as images corresponding to the contact information, for example. The processor 60 executes one or more computerized code of the communication device 1 and other applications, to provide the functions of the communication device 1.

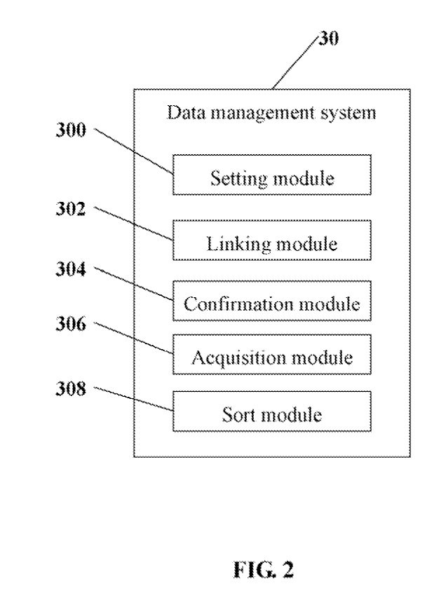

FIG. 2 is a block diagram of one embodiment of the data management system 30 of FIG. 1. In some embodiments, the data management system 30 includes a setting module 300, a linking module 302, a confirmation module 304, an acquisition module 306, and a sort module 308. The modules 300-308 may comprise computerized code in the form of one or more programs that are stored in the storage system 40. The computerized code includes instructions that are executed by the at least one processor 50 to provide functions for modules 300-308. Details of these operations follow.

The setting module 300 sets relevant information of contacts in the contact list 20 to the one or more social network applications 10. In some embodiments, the relevant information may be accounts and/or mail addresses of the contacts to log onto the one or more social network application 10. The contacts in the contact list 20 may have relevant information associated the contacts to the one or more social network applications 10. The setting module 300 further sets a targeted social network application 10 of the communication device 1. The targeted social network application 10 represents one social network application 10 that is logged onto directly when the contacts list 20 is activated. In some embodiments, the targeted social network application 10 may be one social network application 10 that the user regular logs in. The targeted social network application 10 may be set according to user favorites.

The linking module 302 executes the targeted social network application 10 when the contact list 20 is activated, and shows a login interface of the targeted social network application 10 on the display 50. Entry of requested information to the login interface generates access to the login interface of the targeted social network application 10 or another social network application 10 can be selected to log in.

When the targeted social network application 10 is run in the communication device 1, the confirmation module 304 confirms contacts associated with the targeted social network application 10, according to the relevant information of the contacts.

The acquisition module 306 obtains current status of the confirmed contacts from the social network application 10. In some embodiments, the information of the current status may include online, busy, and away status, for example. In other embodiments, the confirmed contacts may be in offline status when the confirmed contacts do not enable the targeted social network application 10.

The sort module 308 arranges all of the contacts in the contact list 20 according to current status, and shows the contact list 20 on the display 50. The sort module 308 arranges confirmed contacts ahead of unconfirmed contacts unassociated with the targeted social network application 10, and arranges the confirmed contacts under current status ahead of the confirmed contacts in offline status. The order of the confirmed contacts in current status, and order of the confirmed contact, and order of the contacts unassociated contacts are still maintained an original arrangement in the contact list 20.

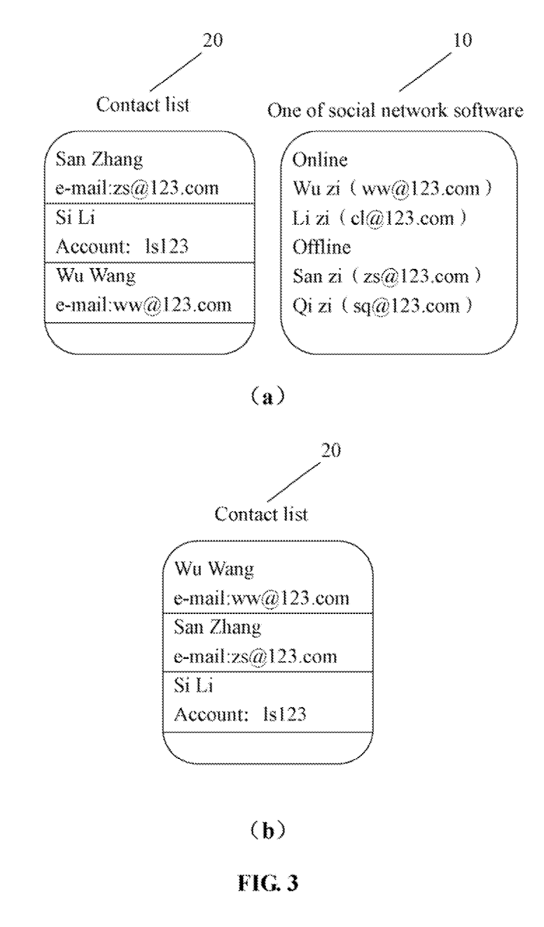

FIG. 3 is a schematic diagram of one embodiment of the data management system of FIG. 1. As shown in FIG. 3(a), the setting module 300 sets relevant information for contacts in the contact list 20 to the one or more social network applications 10. The setting module 300 sets a targeted social network application 10 according to use patterns. In the contact list 20, the relevant information between the targeted social network application 10 and selected contacts may be e-mail addresses. The relevant information between the targeted social network application 10 and another contact may be an account name. Following login to the targeted social network application 10 through e-mail, the confirmation module 304 confirms that the first contacts are associated with the targeted social network application 10. The acquisition module 306 obtains the current status of requested contacts, and determines that the second is currently online. The sort module 308 arranges all of the contacts in the contact list 20. As shown in FIG. 3(b), in the arranged contact list 20, confirmed contacts appear before unconfirmed contacts unassociated with the targeted social network application 10, and a confirmed contact in online status, appears before a confirmed contact “San Zhang” in offline status. In other embodiments, the contacts of the contact list 10 may be shown in other orders.

The grouping contacts system 30 may be optional in the communication device 1.

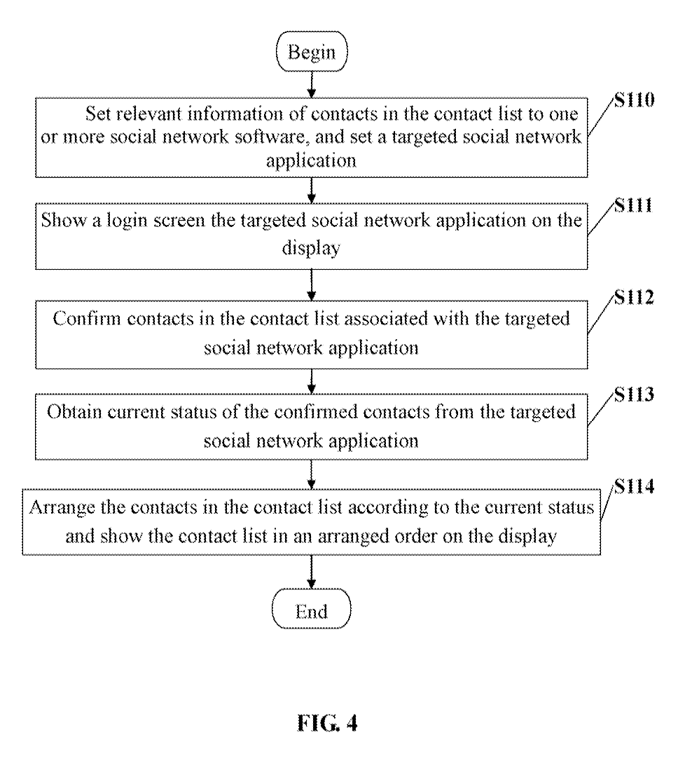

FIG. 4 is a flowchart of one embodiment of a method for data management in a communication device. Depending on the embodiment, additional blocks may be added, others removed, and the ordering of the blocks may be changed.

In block S110, the setting module 300 sets relevant information of contacts in the contact list 20 to the one or more social network applications 10, and sets a targeted social network application 10 according to preference. As mentioned, the relevant information may be accounts and/or mail addresses of the contacts to log in the one or more social network application 10. the contacts in the contact list 20 may have the relevant information that associated the contacts to the one or more social network application 10.

In block S111, the linking module 302 executes the targeted social network application 10 when the contact list 20 is activated, and shows a login interface of the targeted social network application 10 on the display 50. In other embodiments, if the user wants to choose another social network application 10, the user may exit the login interface of the targeted social network application 10 and choose another social network application 10 to log in.

In block S112, when the targeted social network application 10 is run in the communication device 1, the confirmation module 304 confirms contacts associated with the targeted social network application 10, according to the established relevant information of the contacts.

In block S113, the acquisition module 306 obtains current status of the confirmed contacts from the social network application 10. In some embodiments, the information of the current status may include online, busy, and away status, for example.

In block S114, the sort module 308 arranges all of the contacts in the contact list 20 according to the current status of the confirmed contacts, and shows the contact list 20 in an arranged order on the display 50. The sort module 308 arranges the confirmed contacts ahead of unconfirmed contacts unassociated with the social network application 10, and arranges the confirmed contacts in online status ahead of the confirmed contacts in offline status. The order of the confirmed contacts in current status, and order of the confirmed contact, and order of the contacts unassociated contacts are still maintained an original arrangement in the contact list 20.

It should be emphasized that the described inventive embodiments are merely possible examples of implementations, and set forth for a clear understanding of the principles of the present disclosure. Many variations and modifications may be made to the-described inventive embodiments without departing substantially from the spirit and principles of the present disclosure. All such modifications and variations are intended to be comprised herein within the scope of this disclosure and the-described inventive embodiments, and the present disclosure is protected by the following claims.

What is claimed is:

1. A communication device, comprising:
a storage system to store a contact list and one or more social network applications;
a display;
at least one processor; and
one or more programs stored in the storage system, executable by the at least one processor, the one or more programs comprising:
a setting module operable to set relevant information of contacts in the contact list to the one or more social network applications;
a confirmation module operable to confirm contacts in the contact list associated with a specific social network application when the communication device runs the specific social network application, according to the relevant information of contacts;
an acquisition module operable to obtain current status of the confirmed contacts from the social network application; and
a sort module operable to arrange all of the contacts in the contact list according to the current status of the confirmed contacts, and display the contact list in an arranged order on the display.

2. The communication device as claimed in claim 1, wherein the setting module is further operable to set a targeted social network application in the communication device.

3. The communication device as claimed in claim 2, wherein the one or more programs further comprise a linking module operable to display a login interface of the targeted social network application on the display when the contact list is activated.

4. The communication device as claimed in claim 1, wherein the relevant information comprises accounts and/or mail addresses of the contacts to log in to the one or more social network applications, and the contacts in the contact list comprise the relevant information associating the contacts to the one or more social network applications.

5. A computer-implemented method for data management in a communication device, the communication device comprising one or more social network applications and a contact list, the method comprising:
setting relevant information of contacts in the contact list to the one or more social network applications;
confirming contacts in the contact list associated with a specific social network application when the communication device runs the specific social network application, according to the relevant information of contacts;
obtaining current status of the confirmed contacts from the specific social network application;
arranging all of the contacts in the contact list according to the current status of the confirmed contacts, and display the contact list in an arranged order on a display of the communication device.

6. The method as claimed in claim 5, further comprising setting a targeted social network application in the communication device.

7. The method as claimed in claim 6, further comprising showing a login interface of the targeted social network application on the display when the contact list is activated.

8. The method as claimed in claim 5, wherein the relevant information comprises accounts and/or mail addresses of the contacts to log in to the one or more social network applications, and the contacts in the contact list comprise the relevant information associating the contacts to the one or more social network applications.

9. A storage medium storing a set of instructions, the set of instructions capable of executed by a processor to perform a method for data management in a communication device, the communication device comprising one or more social network applications and a contact list, the method comprising:
setting relevant information of contacts in the contact list to the one or more social network application;
confirming contacts in the contact list associated with a specific social network application when the communication device runs the specific social network application, according to the relevant information of contacts;
obtaining current status of the confirmed contacts from the specific social network application;
arranging all of the contacts in the contact list according to the current status of the confirmed contacts, and display the contact list in an arranged order on a display of the communication device.

10. The storage medium as claimed in claim 9, further comprising setting a targeted social network application in the communication device.

11. The storage medium as claimed in claim 10, further comprising showing a login interface of the targeted social network application on the display when the contact list is activated.

12. The storage medium as claimed in claim 9, wherein the relevant information comprises accounts and/or mail addresses of the contacts to log in to the one or more social network applications, and the contacts in the contact list comprise the relevant information associating the contacts to the one or more social network applications.
